(19) United States
(12) Patent Application Publication
(10) Pub. No.: US 2010/0066851 A1
(43) Pub. Date: Mar. 18, 2010

(54) Imaging Apparatus

(76) Inventors: Stuart Pooley, Edinburgh (GB); Peter Cronshaw, Midlothian (GB); Paul Thompson, Edinburgh (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/523,432

(22) PCT Filed: Jan. 23, 2008
(86) PCT No.: PCT/GB2008/000241

§ 371 Date: Oct. 9, 2009

(30) Foreign Application Priority Data
Jan. 24, 2007 (GB) 0701300.6

(51) Int. Cl. H04N 5/225

(52) U.S. Cl. 348/222.1; 348/E05.024

(57) ABSTRACT

Imaging apparatus comprises a projectile imaging device (33), the projectile imaging device (33) comprising imaging means (40, 41) for capturing images of a scene during motion of the projectile imaging device (33) as image data, and motion sensing means (2) for measuring the motion of the projectile device, wherein the apparatus further comprises means for processing (1) the image data in dependence upon the measured motion.

The present invention relates to an imaging apparatus and in particular to a portable device suitable for projection by a user, able to image a scene whilst in motion and to provide images of the scene to the user.

There are many scenarios where personnel place themselves in danger by entering hazardous areas without having been able to fully assess the scope and nature of the hazards that may be present. Such hazardous areas, due to their location or the method of entry to them, may not lend themselves to inspection by conventional methods, such as a robotic vehicle carrying a video camera. Also, there is a limit to the size, weight and amount of equipment that personnel may be expected to carry or to deploy into such areas.

In a first, independent aspect of the invention there is provided imaging apparatus comprising a projectile imaging device, the projectile imaging device comprising: imaging means for capturing images of a scene during motion of the projectile imaging device as image data; and motion sensing means for measuring the motion of the projectile device; wherein the apparatus further comprises means for processing the image data in dependence upon the motion measured by the motion sensing means.

By processing the image data in dependence upon the measured motion it may be possible to obtain useful image data during motion of the projectile imaging device. Image data obtained during motion of the imaging device may be particularly useful as the trajectory of the projectile imaging device may pass over areas not visible from an operator's point of view, enabling imaging of such areas.

The apparatus may be used, for instance, in hazardous situations such as hostage or riot situations. The device may be used in hazardous area inspection by, for instance, the fire service.

The imaging means may be an image sensor, the motion sensing means may be a motion sensor and the processing means may be a processor.

The imaging means may be for capturing images in any range of wavelengths, but preferably the imaging means is for capturing visible or infra-red images.

Preferably, the means for processing the image data is included in the projectile imaging device. In that case, in operation, the image data may be processed at the projectile imaging device, and processed image data may be transmitted from the projectile imaging device.

Alternatively, the means for processing the image data in dependence on the measured motion may be external to the projectile imaging device, for instance at a user's device. In that case the image data may be transmitted from the projectile imaging device without being processed in dependence upon the measured motion, together with output data from the motion sensing means representative of the measured motion.

The projectile imaging device is preferably in a hand-held form. Thus, the projectile imaging device may be easily transportable, and may be used in wide variety of situations. Preferably the projectile imaging device fits within the hand of a user.

Preferably, in operation, the projectile imaging device is untethered. Alternatively, the projectile imaging device may, in operation, communicate with a user device via wireline communication, in which case the projectile imaging device in operation is tethered by the wireline, for instance in the form of fibre optic cabling or electrical cabling, used for communication.

The projectile imaging device may be for throwing or dropping by hand. Thus, the projectile imaging device may be particularly easy to use in the field, without the need for additional launching equipment. Alternatively, if greater range of projection is required, the projectile imaging device may be for projection using a launch device, for instance a pneumatically operated launch device or a catapult or sling. The launch device may comprise, for instance, a gun or cannon. The device may be rifled to make it spin along an axis after launch. The device may also be dropped, for instance from a helicopter or other aircraft.

The image data may be for generation of an image on a display, and the processing means may be configured to adjust the image data with respect to a pre-determined reference point so as to maintain a desired perspective of the image on the display. Thus, an operator or user may be able to view a stable image obtained from the projectile imaging device despite any variation in position and orientation of the device in motion. The device may rotate in the air, in-flight, after being thrown, dropped or otherwise projected. By adjusting the image data so as to maintain a desired perspective of the image on the display, it can be ensured that a user or operator can obtain steady, useful images from the device despite such rotation.

The processing means may be configured to process the image data so as to maintain the perspective of the image on the display along a single direction and with a constant attitude.

The single direction and the constant attitude may be defined with respect to the reference point.

The processing means may be configured to determine the position of the projectile imaging device relative to a or the pre-determined reference point, from the measured motion. Thus, variation of image data representative of the scene imaged by the device during motion of the device may be correlated with the determined position of the device during the motion. The variation of image data may be adjusted to take account of the variation in position of the device.

The image data may comprise a plurality of pixel signals, and the processing means may be configured to offset the spatial co-ordinates of each pixel signal in dependence on the determined relative position of the projectile imaging device.

The processing means may be configured to alter the spatial co-ordinates of each pixel signal to maintain the perspective of the image.

The projectile imaging device may further comprise means for selecting the desired perspective and/or the reference point. By providing means for selecting the desired perspective and/or the reference point in the projectile imaging device itself, it can be ensured that the desired perspective and/or reference point can be selected without the need for additional equipment, for instance without the need to connect the device to, say, a control computer. The selecting means may be selection circuitry.

The selecting means may comprise user-operated selecting means for selecting the current position of the projectile imaging device as the reference point. Thus, a user is able to set the reference point in a particularly straightforward manner.

The user-operated selecting means may comprise a push-button. The user-operated selecting means may also comprise a pointer for selecting a direction to be used as the desired perspective. Operation of the push-button may select the position of the device, or a part of the device for instance the centre of the device, at that time as the reference point, and preferably also selects the direction of the pointer at that time, relative to the selected reference point, to define the desired perspective.

The motion sensing means may be configured to measure acceleration of the device. The motion sensing means may comprise a plurality of accelerometers and preferably further comprises a plurality of angular rate sensors or gyroscopes.

The imaging means may have a field-of-view around the projectile imaging device substantially equal to 360°.

The imaging means may comprise a plurality of wide-angle lenses. The imaging means may comprise two optical assemblies each including a respective wide-angle lens. There may be a narrow blind-band within the 360° field of view caused by the spacing apart of the lenses. The blind band may be reduced or eliminated by, for instance, placing the lenses adjacent to each other in the same plane. In that case, the two images produced by the lenses may be laterally offset by the width of the lenses.

The lenses may be fish-eye lenses, each having a field of view of greater than 180°. In that case, there may be no blind band.

The imaging means may comprise three or more optical assemblies and/or three or more wide-angle lenses, preferably arranged so that the fields-of-view of the lenses overlap. Thus, there may be no blind band.

The projectile imaging device may be substantially spherical or disc shaped. The projectile imaging device may comprise two parts, for example where the device is spherical, the two parts may each be hemispherical.

The apparatus preferably further comprises wireless communication means for transmitting the image data. Alternatively or additionally, the apparatus may comprise wireline communication means for transmitting the image data. The wireline communication means may comprise, for instance, fibre optic or electrical cable. The wireless communication means may be wireless communication circuitry.

A 360° image captured by the device may be represented in two dimensions, preferably prior to transmission, in order to be displayed on an operator's display device.

The wireless communication means may comprise a plurality of antennas, and the processing means may be configured to select at least one antenna for transmission in dependence on the determined relative position of the device.

The projectile imaging device may comprise at least one payload compartment for insertion of a payload. Thus, the functionality of the device may be varied by inclusion of a different payload or payloads within the at least one payload compartment. Thus, the device may comprise one or more payload devices that may be inserted into one or more of the at least one payload compartments.

The payload devices may each have a common type of mechanical or electrical interface. The payload devices may possess different functionalities and capabilities that may augment the functionalities and capabilities of the device itself. The device and any payload devices that are inserted into the payload compartment or compartments may be remotely controlled. Alternatively the device may act autonomously and may control the or each payload device autonomously.

The payload may comprise at least one of a loud speaker and audio circuitry, a detonator and explosive charge, and energy storage means. Alternatively the payload may be a dummy payload. A dummy payload may be included to maintain a desired weight distribution or aerodynamic behaviour of the projectile imaging device in a situation where payload functionality is not required.

The payload may comprise a payload device that includes a wired connection for connection to an external power source. Thus, the device including such a payload device could be positioned so as to connect the wired connection of the payload device to an external power source, to charge the device or to power the device.

The payload may comprise a payload device that includes a wireline data connection, and the device may communicate or interact with a remote, control station via the wireline data connection.

The projectile imaging device may comprise means for recording physical shocks to which it is subject. The means for recording physical shocks may comprise one or more accelerometers. The accelerometers may also form part of the motion sensing means. Preferably there is provided means for comparing the magnitude of a recorded physical shock to a threshold. Any recorded physical shocks that exceed the threshold may be stored, preferably with an associated timestamp. The record of physical shocks may be used to determine if or when maintenance of the device may be required.

The projectile imaging device may comprise storage means for saving image data.

The projectile imaging device may comprise means for recording audio signals.

The projectile imaging device may comprise a pull-out tab for causing the projectile imaging device to power-on.

There may be provided a device that is small, portable and which can be deployed into an area to allow personnel to obtain images of the area in order to better assess that area for hazards from a safe distance. The device may also be reconfigured to allow it to perform a wide variety of specific tasks. The device may be configured to perform more than one task to increase its usefulness when used in different hazardous scenarios.

There may be provided a portable device that provides positionally stabilised video of 360° (or near 360°) coverage of the scene around it by wireless communication to a compatible device held by a user and which maintains the direction of perspective, selected by the user prior to launch of the device, of the scene irrespective of its own movement.

In a further, independent aspect of the invention there is provided a method of imaging, comprising processing image data in dependence upon the measured motion of a projected imaging device, the image data representing images of a scene captured during motion of the imaging device.

The image data may be for generation of an image on a display, and the processing of the image data comprises adjusting the image data with respect to a pre-determined reference point so as to maintain a desired perspective of the image on the display.

The processing of the image data may be such as to maintain the perspective of the image on the display along a single direction and with a constant attitude.

The method may further comprise determining the position of the projectile imaging device relative to a or the pre-determined reference point, from the measured motion.

The image data may comprise a plurality of pixel signals, and the processing may comprise offsetting the spatial co-ordinates of each pixel signal in dependence on the determined relative position of the projectile imaging device.

Preferably, the processing comprises altering the spatial co-ordinates of each pixel signal to maintain the perspective of the image.

In a further independent aspect of the invention, there is provided an untethered, hand-held device for throwing or projection by an operator, comprising means for capturing moving images with a field of view substantially equal to 360° around the device, motion sensing means for measuring the motion of the device in three dimensions, wireless communication means for relaying the images to a display device, and processing means for stabilising the images in attitude and maintaining the perspective of the view of the images relayed to the display device with respect to a point in space pre-determined by the operator.

In another independent aspect there is provided a user device comprising means for receiving from an imaging device image data and data representative of motion of the device, processing means configured to process the image data in dependence upon the data representative of motion of the device, and means for displaying an image represented by the processed image data. Alternatively, the processing means may be located on the projectile imaging device, in which case the image data may be processed in dependence on the data representative of motion at the projectile imaging device rather than at the user device, and the user device may be configured to receive the processed image data rather than the image data and the data representative of motion of the device.

In another independent aspect there is provided a hand-held device for throwing or otherwise projecting by an operator, comprising means for capturing moving images around the device, motion sensing means for measuring the motion of the device, communication means for relaying the images to a display device, and processing means for stabilising the images in attitude and maintaining the perspective of the view of the images relayed to the display device with respect to a point in space pre-determined by the operator. The communication means may comprise wireline communication means, for example, fibre optic cabling or electrical cabling. The wireline communications may be used as a physical tether for the device.

In another independent aspect of the invention there is provided a computer program product storing computer executable instructions operable to cause a general purpose computer to become configured to perform a method as described or claimed herein.

In a further independent aspect of the invention, there is provided imaging apparatus comprising a projectile imaging device, the projectile imaging device comprising: an image sensor for capturing images of a scene during motion of the projectile imaging device as image data; and a motion sensor for measuring the motion of the projectile device; wherein the apparatus further comprises a processor for processing the image data in dependence upon the measured motion.

In a further independent aspect, there is provided apparatus substantially as described herein, with reference to one or more of the accompanying drawings.

In another independent aspect, there is provided a method substantially as described herein, with reference to one or more of the accompanying drawings.

Any feature in one aspect of the invention may be applied to other aspects of the invention, in any appropriate combination. In particular, apparatus features may be applied to method features and vice versa.

Embodiments of the invention will now be described, by way of example only, with reference to the accompanying drawings in which:

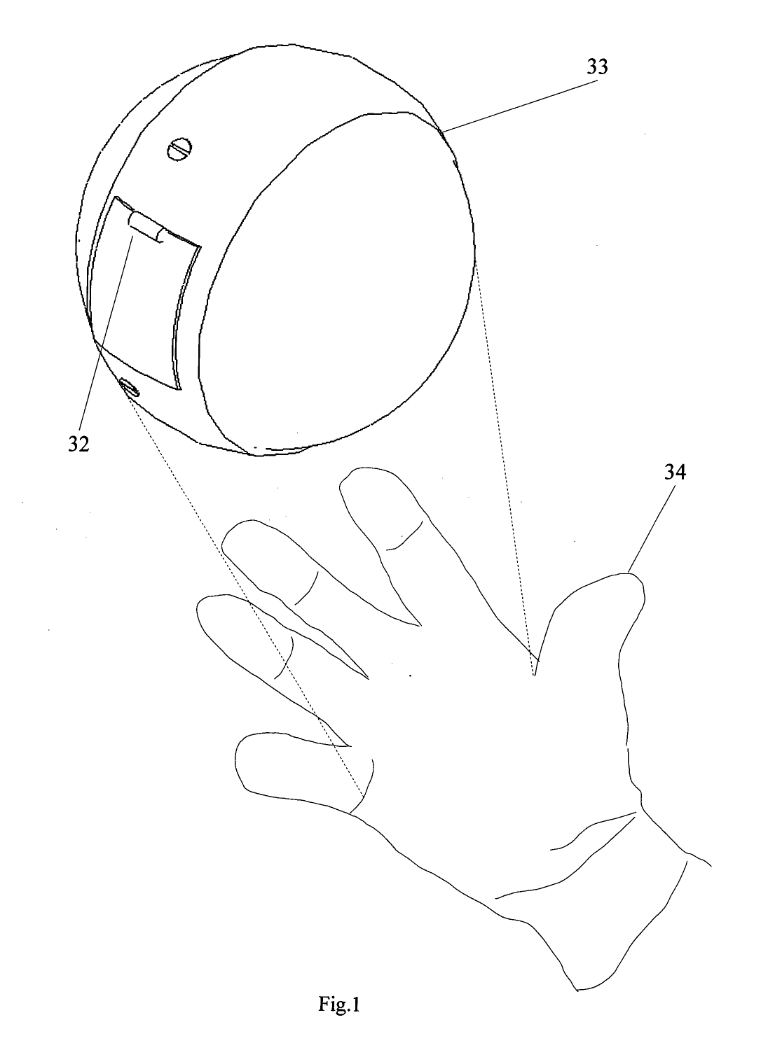

FIG. 1 is a drawing of a device according to a first embodiment, and illustrates the approximate size of the device relative to the hand of a user;

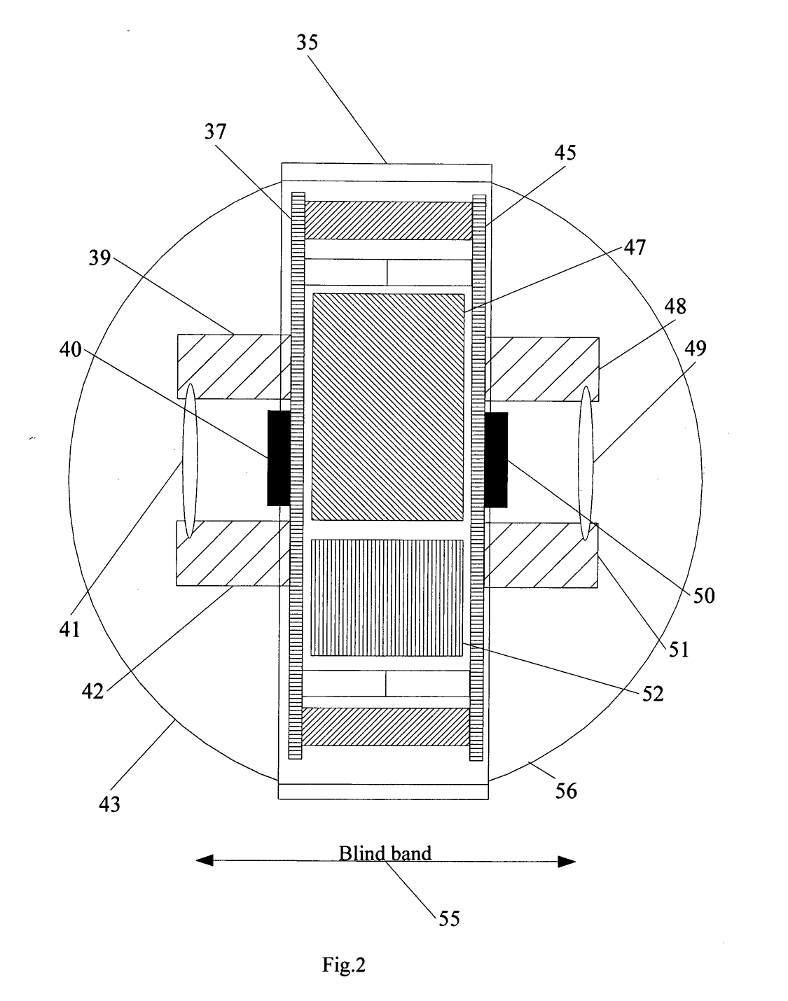

FIG. 2 is a simplified cross-section through the device of FIG. 1, illustrating the positioning of various components with respect to each other; and

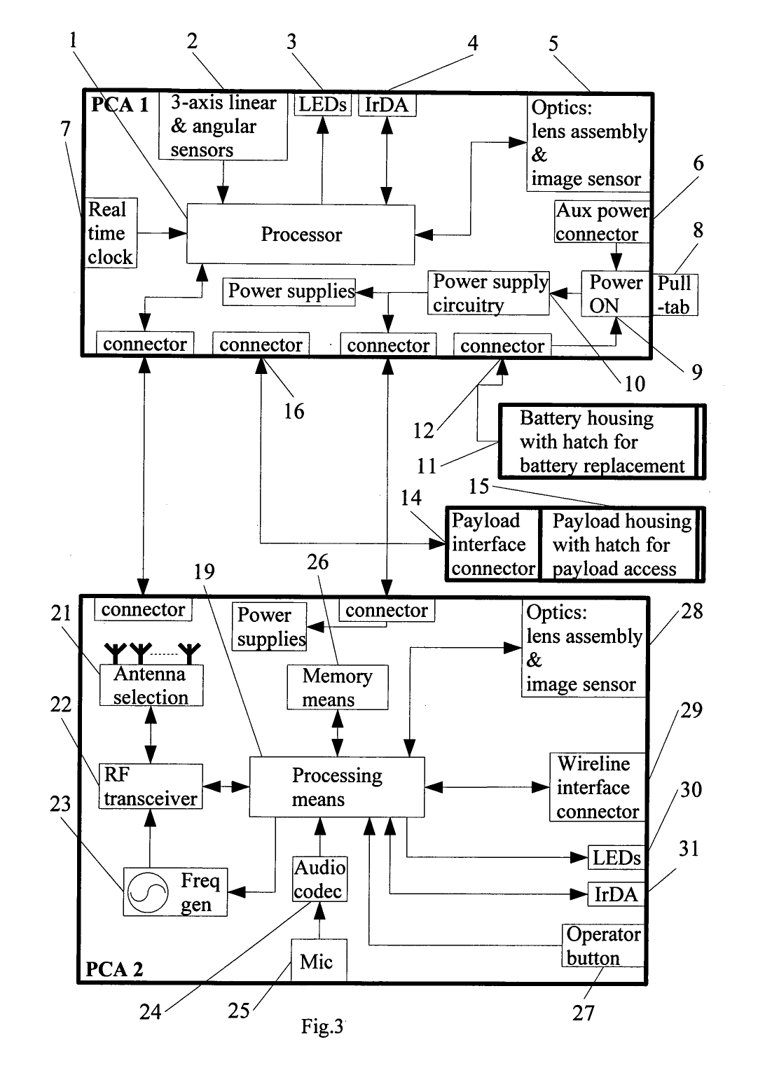

FIG. 3 is a high-level electrical block diagram of circuitry included in the device of FIG. 1;

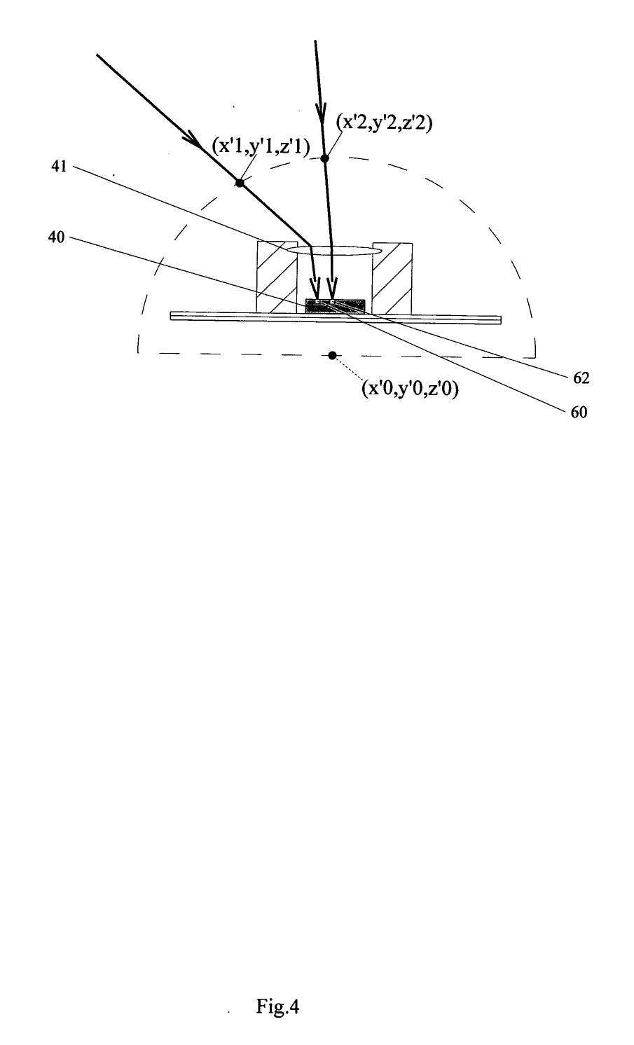

FIG. 4 is a schematic diagram illustrating the offsetting of pixel co-ordinates;

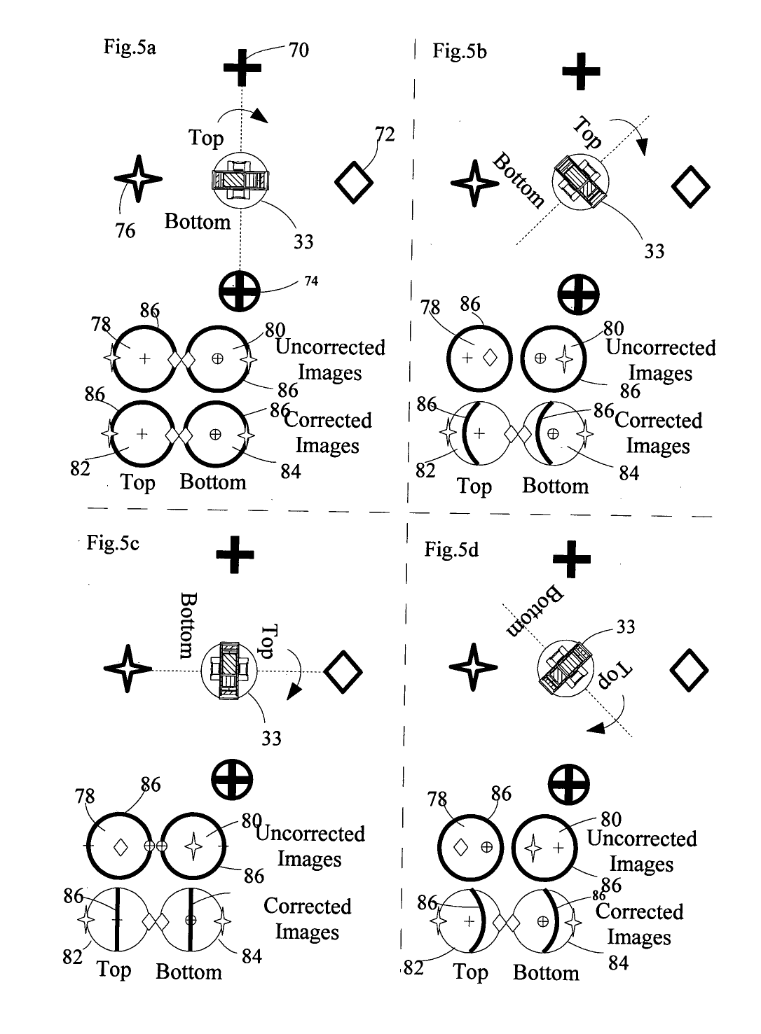

FIGS. 5a to 5d are schematic diagrams illustrating motion of the device and corresponding uncorrected and corrected images produced by the device;

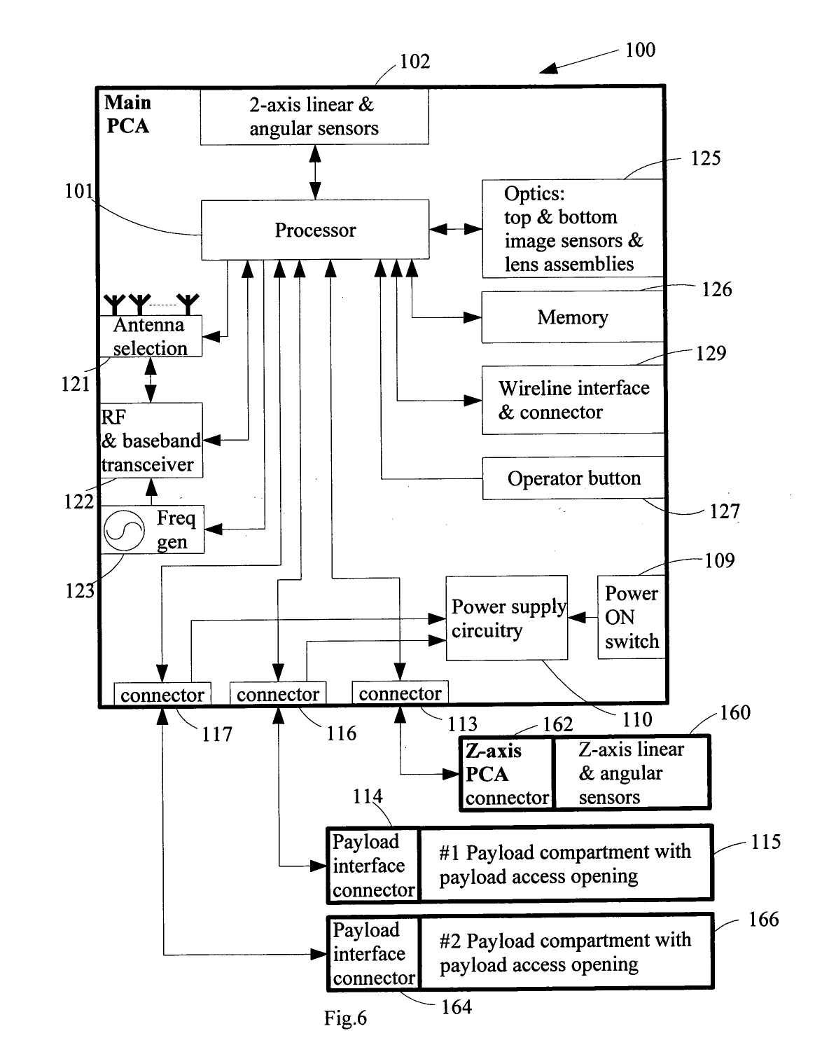

FIG. 6 is a high-level electrical block diagram of circuitry included in a device according to a second, preferred embodiment;

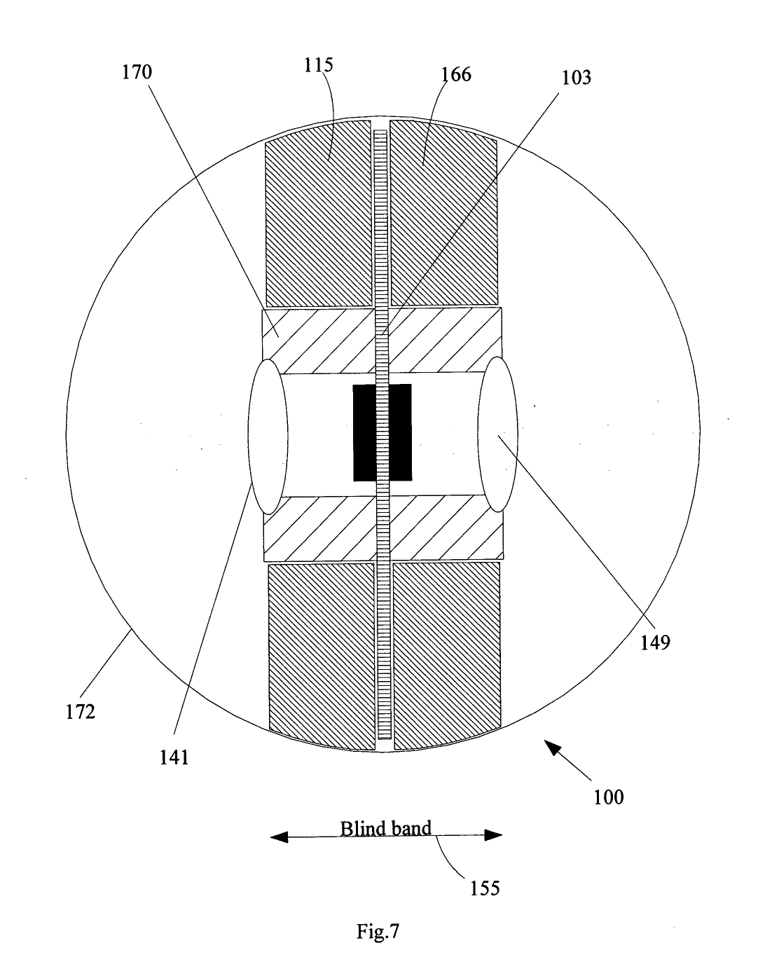

FIG. 7 is a simplified cross section through the device of FIG. 6, showing the relative positions of the lenses; and

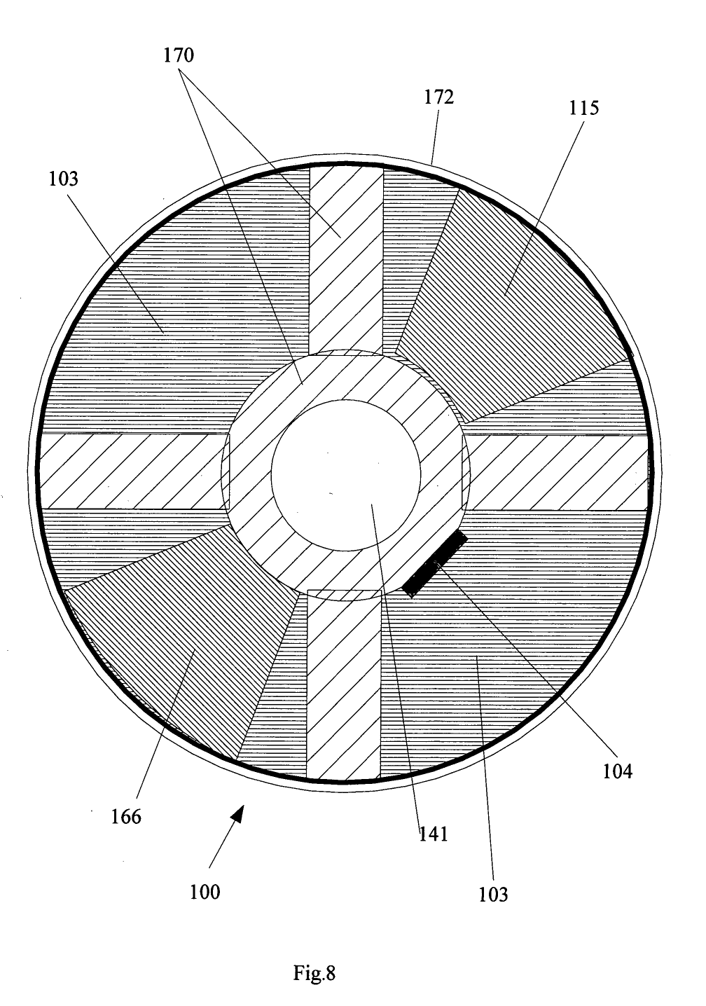

FIG. 8 is another simplified cross section through the device of FIG. 6.

FIG. 1 shows an example of a device according to a first embodiment. It can be seen from FIG. 1 that the device 33 according to the first embodiment is relatively small and fits within the hand 34 of an operator or user. The device is of rugged construction and lends itself to be deployed in a variety of ways, including being thrown or dropped by the operator. In variants of the described embodiment, the device is suitable for deployment by projection using a projection apparatus, for instance a pneumatically operated projection apparatus.

As illustrated in FIG. 2, the device 33 of the first embodiment is constructed from two transparent hemispherical structures 43 56 fixed onto a central frame 35 to form a rugged structure that protects and supports its contents.

FIG. 3 shows, in overview, various electrical and mechanical components of the device 33 and connections between them.

In operation, the device is thrown by or otherwise projected by an operator into a hazardous area that is to be observed. The device captures moving images of the 360° view of the scene around the device (excluding a blind band) in real time. The device relays these images by wireless communication circuitry to a viewing device held by the operator that has corresponding wireless communication circuitry.

The device measures its own motion in three orthogonal dimensions and continually stabilises the 360° image in attitude and maintains the perspective of the view relayed back to the operator's display device with respect to a point in space that has been determined by the operator prior to projecting the device 33.

The operator's display device presents a stable image relayed from the device 33, the attitude of which is maintained stable irrespective of the motion of the device, and the image has a centred perspective that has been chosen by the operator and which persists irrespective of the motion of the device. By viewing the images sent from the device, the operator is made aware of the view of the physical layout and contents of the potentially hazardous area without having to enter it.

The structure of the device 33 and its various components are now described, and then operation of the device 33 is described in more detail.

The device of FIGS. 1 to 3 has a two board construction, and comprises two printed circuit board assemblies PCA1 PCA2. In variants of the embodiment, the components are divided in different ways between the two printed circuit board assemblies. In some alternative embodiments, a single printed circuit board assembly is used or, alternatively, more than two printed circuit board assemblies are used.

The device contains two optical assemblies 5 28, each of which comprises a wide angle lens 41 49 with a 180° field of view. Each lens 41 49 is retained mechanically by an assembly 39 42 48 51 such that it projects an image at its required focal length onto an image sensor 40 50. The image sensor responds to infrared light or visible light, and comprises a charge coupled device. In the case where the image sensor 40 50 responds to visible light, it produces either colour or monochrome image data.

Each optical assembly 5 28 is attached to a printed circuit assembly PCA1 PCA2 37 45. The mechanical assemblies 39 42 48 51 of the optical assemblies are attached by fixings, and each image sensor 40 50 is soldered onto a printed circuit board assembly PCA1 PCA2 37 45.

Each optical assembly 5 faces 180° in the opposite direction to the other optical assembly 28. This allows the entire 360° view around the device to be captured, except for a small blind band 55 around the device where no image can be obtained by the lenses 41 49, which may be present due to the physical separation of the lenses 41 49.

By its nature, this blind band 55 is narrow and would not preclude the operator from being able to identify personnel in the hazardous area.

The device 33 also contains means to allow its motion to be measured along three orthogonal axes. Such motion sensing means is in the form of a motion sensor 2 and comprise accelerometers aligned along each of the orthogonal axes to measure the forces exerted on the device 33 along each such axis and, in some variants, also comprises angular rate sensors or gyroscopes aligned along each of the orthogonal axes to measure the angular rate of rotation along each such axis.

The motion sensor 2 further comprises analogue to digital converter functionality in order to obtain the accelerometer and gyroscope positional data for each orthogonal axis in a digital format suitable for processing. In the described example, the three-axes accelerometer and gyroscope devices are implemented using micro-electro-mechanical systems technology in small, compact formats.

A pushbutton 27 is positioned on the casing of the device 33 for use by the operator to set a reference point in three-dimensional space from which relative positional measurements are made and at the same time to select the operator's desired direction of perspective for images to be relayed from the device to an operator's display. The setting of the reference point and the desired direction of perspective, and the processing and display of images are described in more detail below.

The device 33 also comprises processing means, and in the non-exclusive example of FIGS. 1 to 3, processing circuitry in the form of two processors 1 19 is used to implement the processing means, one on each printed circuit board assembly PCA1 PCA2 37 45.

The processing circuitry 1 19 perform tasks such as to control the image sensors 40 50 shutter speed, exposure time and frame rate, to read the positional information from the motion sensor 2 in order to calculate the motion of the device, to maintain stable the moving images from reference criteria selected by the operator irrespective of the movement of the device, to represent the image data obtained from both optical assemblies 5 28 in two dimensions, to compress this two dimensional moving image content using a suitable image compression algorithm in order to reduce its frequency bandwidth, to control frequency generation circuitry 23, radio frequency wireless transceiver circuitry 22, and antenna selection circuitry 21, and to interface to a payload connector in order to identify, control and operate the payload.

The device 33 also includes wireless communication means, in the form of wireless communication circuitry comprising a wireless transceiver 22, antennae 21 and frequency generation circuitry 23.

The outer surface of the device 33 includes a hatch 32. The hatch 32 may be opened to gain access to a payload compartment 15 47, shown in FIG. 2, within the device that accepts payloads with different functionality that have been designed to mechanically and electrically interface compliantly with the device via a payload interface connector. In variants of the embodiment, no hatch 32 is included. Instead payloads are attached to the device using a plug and socket arrangement, or other securing arrangement, that is able to hold a payload securely within the payload compartment. A plurality of payload compartments are provided in variants of the embodiment.

In the example illustrated in FIG. 1, the payload comprises a loud speaker and audio circuitry that is inserted into the compartment 15 47. Such a payload can convert digital audio signals from the device into amplified analogue audio signals to drive the loud speaker, enabling the device to broadcast audio messages to people in a hazardous area. Such audio messages could take the form of live speech that has been relayed from the operator to the device over the device's wireless communication circuitry 21 22 23. The operator may decide whether or not to command the device to cause the payload to broadcast an audio message in dependence on the images received from the device.

In another example, the payload contains additional energy storage capacity to allow the device 33 to operate for a longer period of time.

The device 33 also contains an energy storage means, such as a battery or supercapacitor or fuel cell, that resides in a compartment 11 52 in the device. In a similar manner to the interchangeable payload, it is possible to gain access to this compartment 11 52 to replace the battery or other energy storage means. In variants of the described embodiment, the device does not have a dedicated battery compartment. Instead, the battery or other energy storage means is installed in one of the payload compartments in the same manner as other payloads.

Electrical connections between the two printed circuit board assemblies PCA1 PCA2, the compartment 11 and the payload compartment 15 are shown in FIG. 3. It can be seen that the payload interface connector 14 is connected electrically to the rest of the device via a connector 16 on a printed circuit board assembly PCA1. The compartment 11 connects to the printed circuit board assembly PCA1 via a connector 12.

The payload may be operated and controlled by the device 33, which, in turn, may be operated and controlled remotely by an operator using a suitable further device (not shown) equipped with wireless communication means.

The device 33 includes a pull out tab 8 whose removal completes the electrical circuit 9 to the power supply circuitry 10 and causes the device 33 to power on. Thus, in order to operate the device 33 the operator must pull out the tab 8, which reduces the likelihood of an accidental powering on of the device.

Memory storage means are contained within the device, consisting of both volatile and non-volatile memory devices 26 including, for example, electronically erasable programmable read-only memory, static random access memory and dynamic random access memory. Provision of such memory devices provides working memory for the processing circuitry 1 19 and also provides the ability to record images by saving them into the memory storage devices 26, thereby providing the ability to replay such saved images. The images may be saved after having been compressed by the processing circuitry 1 19, or may be saved uncompressed.

The device may also be equipped with one or more antenna. In the embodiment of FIGS. 1 to 3, a plurality of antennas are provided, each uniformly positioned along the periphery of the printed circuit board assemblies. The processing circuitry 1 19 continually calculates the current position of the device 33 with respect to a starting point determined by the operator and so is able to select one or more antennae 21 of the antennae available that offer the best line of sight path to that starting point, for use in transmission.

Provision to measure the ambient light intensity in the field of view of each of the optical assemblies 5 28 may be incorporated into the device.

As the operator may throw the device, it may be subject to physical shock. Frequency generation circuitry 23, which generates reference frequencies and clocks for much of the device's circuitry, including the processing circuitry 1 19, employs shock-tolerant components and clock circuit techniques to minimise the interruption caused by a physical shock event. The shock-tolerant components may be mounted using printed circuit board component mounting techniques, such as mounting onto absorbent material to minimise the effect of a physical shock.

The clock circuit techniques include the use of a silicon oscillator, which does not use or contain shock-sensitive resonant components such as crystals, and a clock from such an oscillator is employed to clock a circuit that operates in a supervisory capacity in the processing circuitry 1 19 such that the processing circuitry 1 19 continues to receive a clock during the shock event and does not lose its context.

The device records the magnitude of shock events that it has been subjected to and when a shock event exceeds a threshold level, the magnitude of that shock along each of the three axes is saved into memory 26 along with a corresponding timestamp from the device's real time clock circuitry 7. Such information is subsequently used for maintenance prediction purposes.

For the purposes of clarity, details of some mechanical fixings, such as screws and nuts, have not been shown in FIG. 3. For the same reason antennae, compartment connectors and standard printed circuit board assembly components, have not been shown in FIG. 3.

To turn on the device 33, the operator pulls out the pull-tab 8 which causes the power supply circuit 9 10 to be closed, and power is thereby applied to the device's circuitry. The device initially configures its processing circuitry 1 19 by loading executable code from a memory device. It then performs a self-test and, if successful, it may indicate to the operator that it has passed the self-test by illuminating one or more light emitting diodes 3 30.

The device autonomously interrogates the payload or payloads to determine its identity from a list of possible payloads that have been stored in the device's memory 26, and based on this information the device chooses the correct signal interface and data format for that payload in order to communicate with it and to control it via the payload interface connector 14.

The operator is then able to throw the device and to view the display of the moving images relayed from the device as it rotates and travels along its trajectory. As described in more detail below, the device maintains the perspective of the images along a single direction and with a constant attitude, hereafter referred to as the centred perspective, in order to present stable images of the scene through which the device is moving.

To select a particular centred perspective to be applied to the moving images for a forthcoming use of the device, the operator has to align an arrow marked on the casing of the device along the desired direction and the operator has then to momentarily depress the pushbutton 27 on the casing of the device. The device records this direction and aligns the images it records subsequently with respect to it.

The action of momentarily depressing the pushbutton 27 also causes the device to record any subsequent movement of the device with respect to a position in three dimensional space along three orthogonal axes, hereafter referred to as the x, y and z axes. At the moment the button is depressed, this position in three dimensional space becomes the origin of the x, y and z axes used by the device for all subsequent time, until its power is interrupted or the device is reset. At that moment, this origin is located within the device, at the measurement centre of the motion sensor 2.

The measurement centre of the motion sensor 2 is that position from which its motion is measured. The measurement centre of the motion sensor 2 used to measure the position of the device 33 along the x, y and z axes is hereafter referred to as the positional centre of the device 33. The device 33 measures all subsequent movement from the origin to the positional centre of the device 33, until its power is interrupted or the device 33 is reset.

The device may be reset by depressing the pushbutton 27 and holding it depressed for a period of time that is greater than three seconds. Once this action has been taken, the device 33 continues to operate, however the operator may now select a new centred perspective and origin for the x, y and z axes by once again momentarily depressing the pushbutton 27. The operator then throws or otherwise projects the device 33 into the hazardous area that is to be observed. During the flight of the device 33 image data is obtained, processed and transmitted by the device 33.

An image of the scene of the field of view of each lens 41 49 is projected onto the corresponding image sensor 40 50. As mentioned above, the device 33 contains two optical assemblies 5 28, each consisting of a lens 41 49 with a 180° field of view that is mechanically retained at the correct focal length from an image sensor 40 50 on the printed circuit boards 37 45 by a mechanical housing 39 42 48 51.

The processing circuitry 1 19 receives image data from both of the image sensors 40 50. Since the image projected onto each image sensor 40 50 is round and it has been arranged such that this round image lies within the rectangular outline of the array of pixels that comprise the image sensor 40 50, the processing circuitry 1 19 discards the image data from pixels that are not illuminated by each image sensor's 40 50 corresponding lens 41 49. This reduces the amount of data to be processed.

For each optical assembly 5 28, the processing circuitry 1 19 maps each of the pixels of the image sensor 40 50 onto an imaginary three dimensional sphere, whose radius from the centre of the lens 41 49 is chosen by giving each pixel an offset co-ordinate in three dimensional space which is determined relative to the positional centre of the device 33. These offset co-ordinates onto the two hemispheres are hereafter referred to as x′n, y′n and z′n.

The mapping of pixel signals to offset co-ordinates is illustrated schematically in FIG. 4 which shows, by way of example, light rays directed by lens 41 onto two pixels 60 62 of the image sensor 40.

The origin of each light ray is in one-to-one correspondence with a pixel of the image sensor 40. Each pixel is also in one-to-one correspondence with a point x′n,y′n,z′n, where n=0, 1, 2 . . . , on a notional hemisphere or sphere of centre x′0,y′0,z′0 around the lens and image sensor assembly, through which the rays of light from an imaged scene pass before arrival at the lens 41 and image sensor 40, as illustrated in FIG. 4. The co-ordinates (x′n,y′n,z′n) are defined with respect to a nominal reference point x′0,y′0,z′0 within the volume of the device, for instance at the centre of the device.

The mapping of x′n,y′n,z′n co-ordinates to pixels of the image sensor may be determined by experimentation or by calibration or may be determined by calculation based on the physical relationship between, and performance of, the lens and image sensor.

As mentioned above the device contains a motion sensor 2, which measures the rotational and translational motion of the device and converts the resulting positional data into a digital format and makes it available to the processing circuitry 1 19 in order to calculate the linear and angular movement of the device 33.

The processing circuitry 1 19 performs trigonometric calculations on the x′n, y′n and z′n co-ordinates of each pixel's projection onto an hemisphere or sphere in order to alter their x′n, y′n and z′n co-ordinate values to compensate for motion of the device 33 such that the centred perspective is maintained in a fixed orientation and the attitude of the display is stable. Thus, the measured change in angle obtained from the motion sensor is used to determine the trigonometric correction to be applied to the x′n, y′n and z′n co-ordinates that correspond to each pixel of the image sensor, in order to stabilise the image from the sensor in direction and attitude

In the mode of operation described above, the pixel signals are represented by Cartesian co-ordinates (x,y,z) and the pixel signals are mapped to offset Cartesian co-ordinates (x′, y′ and z′) in accordance with trigonometric calculations to take account of the motion of the device (which may also be referred to as correction of the pixel signals or image). The device is not limited to using the Cartesian co-ordinate system or to correction of the signals using trignonometric calculations. Any suitable co-ordinates may be used, for instance spherical co-ordinates, and any suitable mapping process for pixel signals to take account of the motion of the device may be used.

An example of the mapping of pixel signals to correct images to take account of motion of the device is illustrated in FIGS. 5a to 5d. The device 33 is shown schematically in different rotational positions relative to four fixed objects 70 72 74 76 in each of FIGS. 5a to 5d. The labels top and bottom in FIGS. 5a to 5d indicate the sides of the device that are at the top and bottom in FIG. 5a, before the device has been rotated. The dashed line in each of FIGS. 5a to 5d is representative of the optical axis of each of the wide angle lenses included in the device 33.

The two hemispherical images represented by the pixel produced by the device 33 both before correction 78 80 and after correction 82 84 to take account of the rotation, or other motion, of the device 33 are illustrated schematically in each of FIGS. 5a to 5d. The position of the blind band 86 is also shown schematically in FIGS. 5a to 5d.

It can be seen that for the corrected images 82 84 the fixed objects 70 72 74 76 are in the same positions in the image in each of FIGS. 5a to 5d, regardless of the rotation of the device 33.

The processing circuitry 1 19 may then unwrap the two corrected, hemispherical images using geometry to create two dimensional representations of each image, and may apply the image data of these two dimensional representations to an image compression algorithm, for example a vector quantisation algorithm, in order to reduce the frequency bandwidth of the moving image data. The image data is then taken from the processing circuitry and modulated onto a radio frequency carrier for transmission to the operator's device by the wireless communication circuitry comprising the wireless transceiver 22, antennae 21 and frequency generation circuitry 23.

The frequency channel bandwidth and modulation method employed by the transceiver 22 are commensurate with the data bandwidth requirements of the device. The factors affecting the required bandwidth are, for example, the resolution of the image sensors 40 50, the frame rate of the moving images and the extent of any image compression that is achieved.

The processing circuitry 1 19 is continuously aware of the orientation of the device with respect to the origin and so, in a variant of the described embodiment, is able to determine which antenna 21 is positioned to offer the most direct transmission path back to the origin, and to instruct transmission from that antenna. Such a transmission path is likely to offer the lowest error rate to the transmitted signal.

The device's wireless communication circuitry 21 22 23 is also able to receive data from the operator's device, which includes corresponding wireless communication circuitry.

The optical assemblies, image sensor, motion sensor, processing circuitry and wireless communication circuitry continue to operate as described above throughout the flight of the device, as the device rotates and moves along its trajectory.

The operator's device receives the image data sent by the device during the flight of the device and displays a real-time image on the display throughout the flight. Because of the processing of the image data performed by the processing circuitry of the device, in dependence on the measured motion of the device, the image displayed on the operator's display maintains the same pre-determined perspective, along a single direction relative to the device and with a constant attitude throughout the flight, despite the movement along the trajectory and rotation of the device. Thus, the operator is able to assess the nature of any hazards that are present easily and in real-time. While the most useful visual information is likely to be provided when the device is in mid-flight, it will continue to function after it comes to rest, and continue to obtain, process and transmit image data.

On projecting the device into the area and observing the moving images relayed by it, the operator is able to assess the area over and around which the device passes and make an informed decision concerning the area and the possible operation of the payload included in the device. If appropriate the operator can send a command to the device that causes it to send a signal across the payload interface connector 14 to cause a desired operation of the payload. Alternatively, the operator may view the moving images of the area that have been relayed by the device and decide that it is inappropriate to operate the payload.

In the example described above, the images are displayed in real time on the operator's display. In alternative examples of operation of the device the image data are stored at the operator's device and viewed at a later time. The image data may also be stored at the device itself, either before or after processing, and transmitted to the operator's device at a later time, for instance after the device has landed and come to rest.

The processing circuitry 1 19 processes the image data in dependence on the motion of the device prior to transmission to the operator's device, so that the received image data may be used to produce an image for display, without additional processing being required at the operator's device in order to compensate for the motion of the device. In an alternative mode of operation, the processing of the image signals to compensate for motion of the device described above is performed by a processor external to the device, for instance at the operator's device, rather than a processor included in the device. In that case, the device 33 transmits to the operator's device image data that has not been processed to compensate for motion of the device together with output data from the motion sensor, for processing.

The projectile imaging device may be used, for example, in scenarios where personnel, such as first responders or soldiers, need to enter hazardous areas, such as collapsed buildings, or in close quarters combat scenarios.

In such hazardous areas, it can be useful to be able to remotely operate at a safe distance a device deployed into such an area in order for that device to perform a specific task. One example of this is to be able to detonate an explosive charge under remote control. Another example of this is to allow the operator to broadcast audio messages from the device to people in the hazardous area, either in the form of live speech or pre-recorded messages while the operator is at a safe distance from the device. The described embodiment enables the remote operation of such devices.

A second, preferred embodiment of a projectile imaging device 100 is shown in FIGS. 6 to 8. The functionality of the second embodiment are similar to those of the first embodiment, and many of the components of the first and second embodiments are the same or similar.

FIG. 6 shows, in overview, various electrical and mechanical components of the device 100. Other components that are present in the first embodiment but not shown in FIG. 6 may be considered to also be present in the second embodiment or in variants of the second embodiment.

As with device 33 of the first embodiment, the device 100 has a two board construction and comprises two printed circuit board assemblies (PCAs) 103 104. Circuitry is divided relatively equally between the two circuit board assemblies PCA1 PCA2 for device 33 of the first embodiment, with much of the control and processing circuitry associated with one of the lenses being on one circuit board assembly PCA1 and much of the circuitry associated with the other of the lenses being on the other circuit board assembly PCA2. In contrast, for device 100 of the second embodiment the majority of components, including two-axis (x and y) linear and angular motion sensors and associated circuitry 102, are on a main circuit board assembly 103, and the other circuit board assembly 104 is used only for z-axis linear and angular motion sensors 160.

The device 100 also includes a processor 101, antenna selection circuitry 121 and associated antennas, an r.f. and baseband transceiver 122 and associated frequency generator 123, two image sensors 125, a memory 126, a wireline interface and connector 129, an operator button 127 for setting a desired reference point and perspective, and power supply circuitry 110. The device 100 is turned on and off using an on/off switch 109 rather than a pull out tab.

The device 100 also includes connectors 113 116 117 that are used to connect the main circuit board assembly 103 to the z-axis circuit board assembly 104 via z-axis circuit board connector 162, and to payload interface connectors 114 164. The payload interface connectors 114 164 are used to connect to payloads installed in two payload compartments 115 166 that are included in the device 100.

FIG. 7 shows the device 100 in simplified cross-section, and is an equivalent view to that of device 33 in FIG. 2. The device 100 is of similar construction to the device 33 but it can be seen that the payload compartments 115 166 have been moved relative to the lenses 141 149, in comparison to the position of the payload compartment 47 of the device 33, in order to decrease the spacing between the lenses 141 149 and thus to reduce the size of the blind band 155.

The device 100 includes supporting metalwork and lens assemblies 170 for maintaining the lenses 141 149 in the correct position. The outer surface 172 of the device 100 includes openings for access to the payload compartments 115 166. In the device 100 no hatches to the payload compartments 115 166. The payloads are slid into the payload compartments along a card guide arrangement.

FIG. 8 shows the device 100 in another simplified cross-section, viewed along the optical axis of one of the lenses 141. The z-axis printed circuit board assembly 104 is shown and is attached to the supporting metalwork 170 and connected to the main printed circuit board assembly 103.

Further additional or alternative features are provided in variants of the first and second embodiments or in alternative embodiments or alternative modes of operation. In one such alternative embodiment it is possible to communicate with the device by means of an infrared serial data link that may be provided between the device and the operator's device. In such an embodiment, the wireless communication circuitry is infrared wireless communication circuitry 4 31 and the operator can transfer information and data to and from the device's infrared wireless communication circuitry 4 31 using a compatible device with a corresponding infrared wireless communication circuitry. Such information may, for example, include encryption keys to be used by the device's processing circuitry and its wireless communication means to encrypt the wireless transmissions such that they may be decoded by a device that has knowledge of the encryption key.

In another alternative mode of operation, the device contains an auxiliary power connector 6 that can be used to connect to a source of electrical power other than that of the energy storage means that resides in the device's energy storage means compartment. In order to turn on the device while powering it via the auxiliary power connector 6, it is still necessary to remove the pull-tab.

In another alternative mode of operation, real time clock circuitry real-time clock circuitry included in the device provides chronological data in a suitable format to the processing circuitry. Such data may be used by the processing circuitry to periodically timestamp the moving images relayed back to the operator, or to timestamp data that is saved into the memory storage devices in the device.

In another alternative mode of operation, the device uses a wireline interface, comprising a connector and associated physical and protocol circuitry such as an ethernet interface, to communicate with a compatible device having a corresponding wireline interface. The use of wireline communications can provide a similar or greater data bandwidth than wireless communications. The wireline interface may be used to control the device and to obtain moving images from the device in the same manner as occurs via the device's wireless communication circuitry.

The wireline interface may be used, for instance, when a device has been deployed into a scenario where it is to be powered from its auxiliary power connector in a physical location from which it commands a scene that may be observed by an operator remotely using wireline communication. If the wireline interface is used in the case where the device is thrown or otherwise projected, then the wireline is paid-out to the device whilst in flight.

In such configurations, in which the wireline interface is used, power may be supplied via the wireline or associated cabling, and the device is then capable of operating for a longer period of time than the capacity of its own energy storage means would allow. In such a scenario, the device could be used to allow an operator to remotely observe a scene over a long period of time and to operate a payload at any time during that period.

In yet another alternative embodiment, the device comprises means to record audio signals in the vicinity of the device using audio recording means consisting of an audio coder/decoder 24 device and a microphone 25. The audio signals may be relayed back to a suitably equipped operator's device either via the device's wireless communication circuitry or the device's wireline interface connector 29 129 and associated physical and protocol circuitry. Alternatively the device may save such audio signals into its memory.

In different embodiments, either one processor or more than one processor may make up the processing circuitry. In cases where more than one processor is employed, the processors used may be the same or different, for example, they may be one or more field programmable gate arrays or one or more microprocessors or a combination of both of these.

In the non-exclusive example of FIGS. 1 to 3, the device 33 is shown to contain two approximately equally sized printed circuit board assemblies PCA1 PCA2 37 45 on which the electronic circuitry to implement the functionality of the device is located and apportioned as per FIG. 3. In other examples of the device, the printed circuit board assemblies PCA1 PCA2 37 45 are otherwise implemented such that the circuit functionalities of FIG. 3 are differently apportioned to each printed circuit board assembly or to a single printed circuit board assembly, including examples where the device employs one or more processing means in a manner different to the configuration of the two processors 1 19 shown in the non-exclusive example of FIG. 3. Similarly, the device may employ zero, one or more memory means in a manner different to the example of the device illustrated in FIG. 3.

It will be understood that the present invention has been described above purely by way of example, and modifications of detail can be made within the scope of the invention.

Each feature disclosed in the description, and (where appropriate) the claims and drawings may be provided independently or in any appropriate combination.

1-33. (canceled)

34. Imaging apparatus comprising a projectile imaging device, the projectile imaging device comprising:
imaging means for capturing images of a scene during motion of the projectile imaging device as image data comprising a plurality of pixel signals for generation of an image on a display; and
motion sensing means for measuring the motion of the projectile device in-flight;
wherein the apparatus further comprises processing means for processing the image data in dependence upon the motion measured by the motion sensing means, the processing means being operable to vary the image data obtained in-flight by offsetting spatial co-ordinates of each pixel signal to compensate for motion measured by the motion sensing means in-flight so as to maintain a desired perspective of the image on the display.

35. Apparatus according to claim 34, wherein the means for processing the image data is included in the projectile imaging device.

36. Apparatus according to claim 34, wherein the processing means is configured to adjust the image data with respect to a pre-determined reference point so as to maintain the desired perspective of the image on the display.

37. Apparatus according to claim 36, wherein the processing means is configured to process the image data so as to maintain the perspective of the image on the display along a single direction and with a constant attitude.

38. Apparatus according to claim 34, wherein the processing means is configured to determine the position of the projectile imaging device relative to a or the pre-determined reference point, from the measured motion.

39. Apparatus according to claim 34, wherein the imaging means comprises a plurality of pixels and the processing means is configured to map each pixel to a respective projection on an imaginary sphere defined with respect to a point within the device.

40. Apparatus according to claim 39, wherein the offsetting of the spatial co-ordinates of each pixel signal to compensate for measured motion comprises using a measured change in angle of the device obtained from the motion sensing means to determine a trigonometric correction to be applied to spatial co-ordinates of the projections on the imaginary sphere.

41. Apparatus according to claim 34, wherein the projectile imaging device further comprises means for selecting the desired perspective and/or the reference point.

42. Apparatus according to claim 34, wherein the imaging means has a field-of-view around the projectile imaging device substantially equal to 360°.

43. Apparatus according to claim 34, wherein the imaging means comprises a plurality of lenses.

44. Apparatus according to claim 34, further comprising wireless communication means for transmitting the image data.

45. Apparatus according to claim 34, wherein the motion sensing means comprises at least one accelerometer.

46. Apparatus according to claim 34, wherein the motion sensing means comprises at least one gyroscope.

47. A method of imaging, comprising capturing images of a scene during in-flight motion of a projectile imaging device as image data comprising a plurality of pixel signals for generation of an image on a display, measuring motion of the projectile device in-flight, and processing the image data in dependence upon the measured motion, wherein the processing comprises varying the image data obtained in-flight by offsetting spatial co-ordinates of each pixel signal to compensate for the motion measured in-flight so as to maintain a desired perspective of the image on the display.

48. A computer program product storing computer executable instructions operable to cause a general purpose computer to become configured to process image data comprising a plurality of pixel signals for generation of an image on a display, wherein images of a scene during in-flight motion of a projectile imaging device are captured by imaging means included in the projectile imaging device as the image data, motion of the projectile device is measured in-flight, and the processing of the image data comprises varying the image data obtained in-flight by offsetting spatial co-ordinates of each pixel signal to compensate for the motion measured in-flight so as to maintain a desired perspective of the image on the display.
